(19) United States
(12) Patent Application Publication
(10) Pub. No.: US 2004/0160029 A1
(43) Pub. Date: Aug. 19, 2004

(54) Adjustable birdcage tube and radius arm

(76) Inventor: Ricky Dean Hamby, Rockwood, TN (US)

Correspondence Address: Ricky Dean Hamby, 151 S. Roane St., Harriman, TN, 37748, US

(21) Appl. No.: 10/356,797

(22) Filed: Feb. 3, 2003

(51) Int. Cl. B60G 1/00

(52) U.S. Cl. 280/124.1

(57) ABSTRACT

Adjustable Birdcage Tube and Radius Arm add adjustment and versatility to existing birdcage technology in the dirt late model racing industry.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISK APPENDIX

Not Applicable”

### BACKGROUND OF THE INVENTION

The Adjustable Birdcage Tube and Radius Arm is applicable primarily to the dirt late model racing industry.

The tube and arm are part of a birdcage assembly that allows quicker, finer, and easier adjustment of 4-link suspensions. Before, without this assembly adjustment wasn't attainable, because it required a different set of birdcages to work, requiring much labor.

### BRIEF SUMMARY OF THE INVENTION

The Adjustable Birdcage Tube and Radius Arm is an improvement to existing birdcage assemblies which are used on dirt late model rear ends.

This assembly is designed to allow adjustment of radius rod angles on a 4-link suspension, it also allows adjustment or rear roll steer, through positioning of arm on tube.

It solves the problem of adjustment, which is easier, quicker, and finer. Before, without this arm and tube, these adjustments were not attainable and the only solution was to change to another set of birdcages.

It might also be added that this assembly now allows it to be used on a wide variety of chassis' in the industry making it very versatile.

### BRIEF DESCRIPTION OF THE SEVERAL VIEWS OF THE DRAWING

FIG. 1A: Adjustable Birdcage Tube

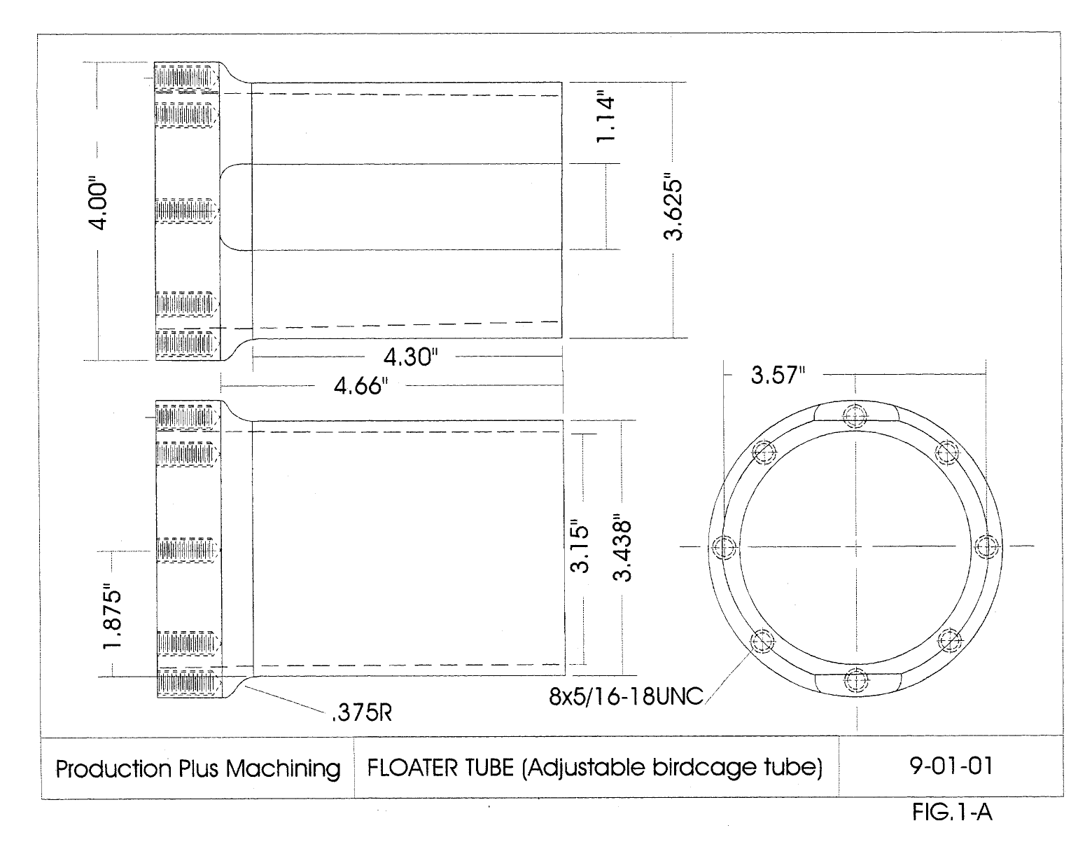

FIG. 2A: Adjustable Birdcage Radius Arm (Slides onto FIG. 1A)

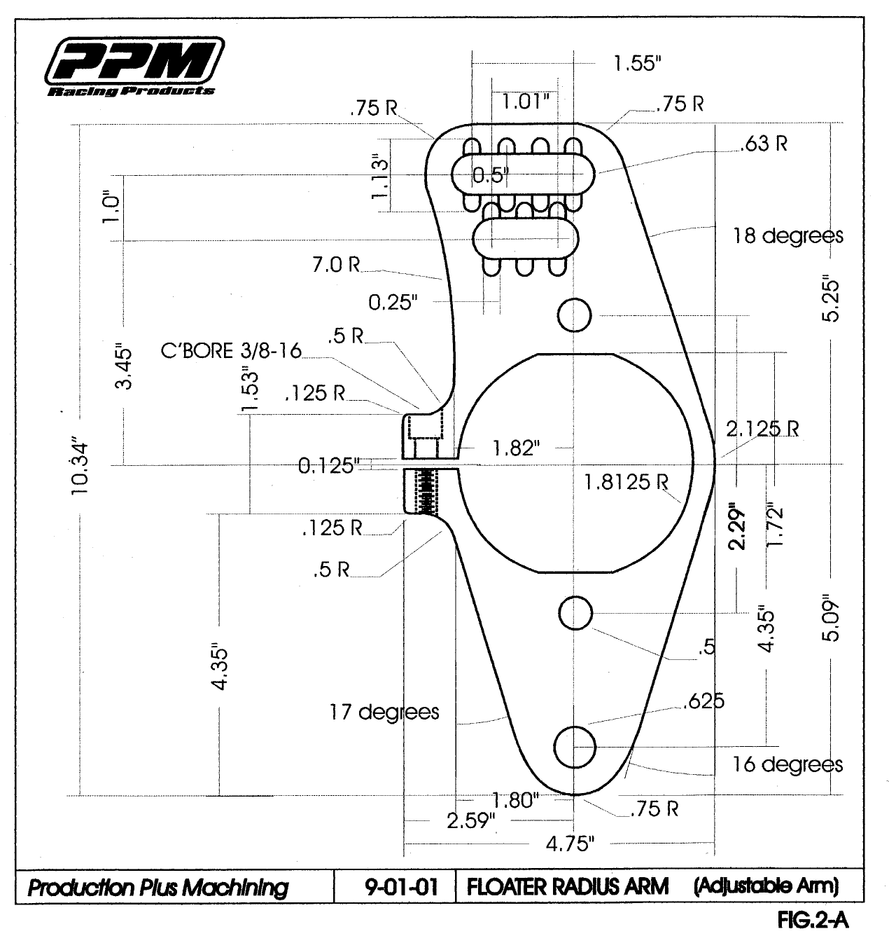

FIG. 3A: Assembly Diagram for Birdcage (FIG. 1A & FIG. 2A along with other components of birdcage assembly)

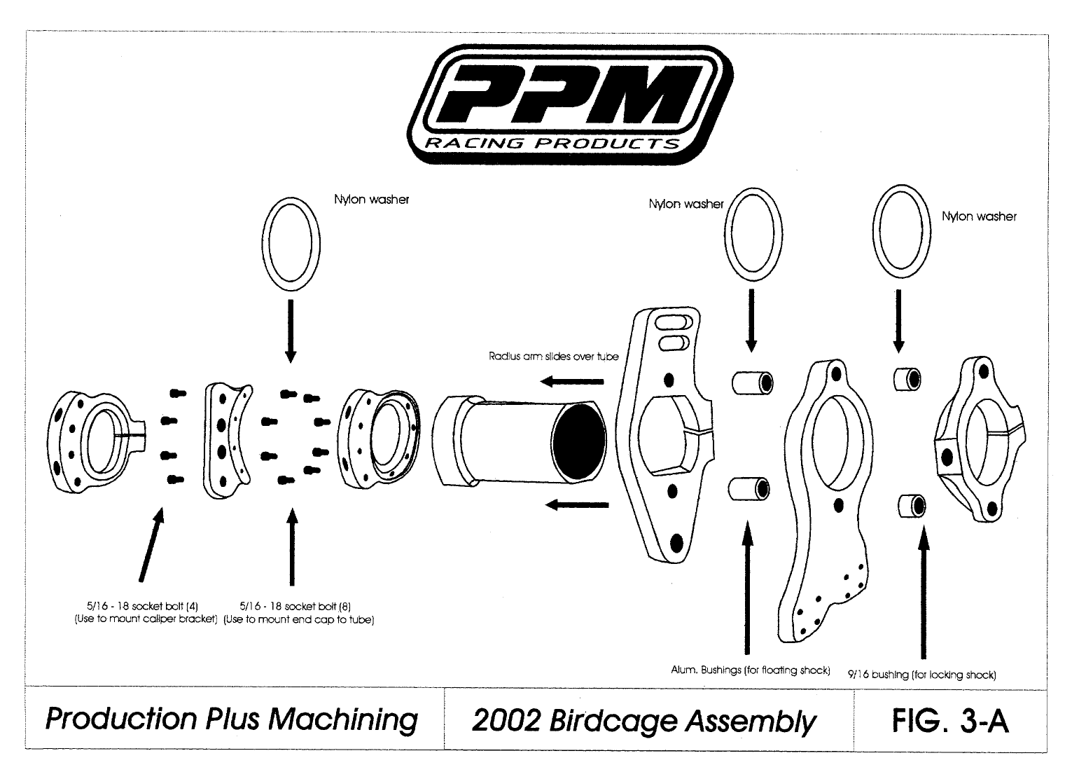

### DETAILED DESCRIPTION OF THE INVENTION

The Adjustable Birdcage Tube and Radius Arm are components on a birdcage assembly. The birdcage assembly is used on rear ends of dirt late model race cars. The birdcage assembly rotates on the axle tube of the rear end. Each assembly operates two (2) link bars (thus 4-link) which attaches to chassis and radius arm. The movement of these arms result in different handling results of the chassis. The adjustable arm allows movement from side to side, parallel to axle tube, which before wasn't attainable. This new ability to move radius arm from side to side allows finer adjustment of chassis and also allows the ability to mount birdcage to any chassis in the industry.

The Adjustable Birdcage Tube and Radius Arm are made of T-6061 metal alloy and machined to precise specifications.

1. What I claim as my invention is the adjustability and versatility that the birdcage tube and radius arm achieve.
